(19) United States
(12) Patent Application Publication
(10) Pub. No.: US 2003/0189836 A1
(43) Pub. Date: Oct. 9, 2003

(54) Boat trailer employing immersible fiber-optic lighting means

(76) Inventors: Teddy Burch Sparling, Sarasota, FL (US); Jordan Lee Gay, Sarasota, FL (US)

Correspondence Address: Teddy Burch Sparling, 2641 49th Street, Sarasota, FL, 34234, US

(21) Appl. No.: 10/288,140

(22) Filed: Nov. 5, 2002

Related U.S. Application Data
(60) Provisional application No. 60/370,036, filed on Apr. 4, 2002.

(51) Int. Cl. B60Q 1/26; F21V 8/00

(52) U.S. Cl. 362/485; 362/511; 362/499; 362/540

(57) ABSTRACT

A boat trailer has a plurality of light sources housed within a sealed enclosure. The sources are electrically connected to a towing vehicle's lighting system and optically coupled through light condensing means to fiber-optic connecting fittings. Electrical circuitry for light source emitting elements is disposed within the enclosure and a multi-conductor electrical bulk-head connector is on the enclosure. A plurality of fiber-optic cables have environmentally securing end connectors. Fiber-optic cable tap devices function to extract a specific percentage of the light transmitted through a fiber-optic cable to a side outlet for distribution among a plurality of emitting apertures performing similar lighting functions. Light emitting apertures with light diffusion and control from the entering beam to the full area of the light emitting aperture is accomplished through lenses and/or critical angle reflectors.

### RELATED APPLICATION

This application is based upon Provisional Application No. 60/370,036 filed Apr. 4, 2002.

### FIELD OF INVENTION

This invention relates to lighting systems for boat trailer vehicles, and more specifically, to lighting systems for “float-on” type trailers whereby light emitting elements are subject to immersion in water.

The use of conventional boat trailer lighting systems is known in the prior art. More specifically conventional boat trailer lighting systems used for running, stop, turn signal, hazard, license tag, side marker, and back-up lights typically use light fixtures comprising an incandescent lamp, a reflector, and a lens. The light fixtures are disposed at desired and/or required light output locations. The lamps are electrically connected to a towing vehicle's respective lighting circuits via a male-female “pig-tail” connector, a wiring harness, and a lamp holder within the light fixture.

A lamp and reflector light source typically has the lamp filament disposed at the focal point of a parabolic reflector. A portion of the light emitted by the filament is reflected outward toward the lens as a roughly coherent beam. The lens is used to color filter and to shape the beam to meet vehicle lighting requirements. Typically, in a lamp reflector system, only about thirty percent of the visible light emitted from the lamp filament is collected and directed into the useful lighting area; furthermore, in incandescent lamps only about 1.5% of the input power is converted to red light. The majority of the input power is converted to detrimental heat and infrared radiation, and a proportionally small amount of ultraviolet radiation.

Conventional boat trailer lighting systems are problematic due to submergence of the electrical components and light emitting elements commensurate with exposure to physical damage during boat launching, recovery, and trailer maneuvering.

The aforesaid conventional boat trailer lighting systems have been and are particularly troublesome in the following ways. Short-lived incandescent lamps necessitate frequent replacement commensurate with failures during operation that result in a user's violation of traffic regulations. Lamp failures result from shock and vibration, water intrusion into lighting fixtures yielding thermal shock rupture of lamp glass envelopes, electrical shorting and/or contact failures from corrosion and/or water conductance at lamp base/socket interfaces. These intrusions are typically due to, fractured lenses and/or housings, lens-to-housing gasket failures and/or misassembly, and/or fixture entrance wire seal deterioration, Electrical shorts result from wire chaffing and/or insulation damage. Finally, corrosion of electrical connector and wire splicing devices occurs, particularly the traditional pig-tail electrical connector coupled to the towing vehicle.

U.S. Pat. No. 4,811,171 to Viola discloses an electrical to optical boat trailer lighting distribution system. In an attempt to address the deficiencies of conventional boat trailer lighting systems, Viola teaches an optically compartmented enclosure, with each compartment housing an incandescent lamp assembly. Each compartment is intended as an illumination source for a particular lighting function. The housing is attached to the ubiquitous winch post of the trailer structure and has a traditional “pig-tail” type electrical input connector portion shown to mate with a corresponding output connector portion, wired to the towing vehicle's electrical signal lighting circuits.

Viola includes a device purposed to turn light through a 90 degree angle, consisting of an enclosure and a flat reflector disposed 45 degrees to the entering and exiting light paths.

In Viola, a multitude of rigid, optionally coated, plastic rods are proposed to function as light pipes or waveguides. The rods are hot formed to conform and attach to the trailer frame. One end of the rods is shown to protrude into a compartment of the aforesaid light source enclosure with the other ends shown to protrude into the light turning device and/or a taillight assembly.

Viola's disclosure does not indicate reflectors, condensing lenses, or other means for concentrating and directing the light from the aforementioned incandescent lamp filaments into the plastic rods. Without such means, only a small portion of the lamps' usable light will enter the plastic rods. Likewise, no light guiding means is shown within the aforementioned turning device; therefore, through scattering, only a small portion of the usable light will transit the device. Additionally, most plastics attenuate light with wavelengths greater than 580 nanometres. Running, turning, and stop signaling requires light with wavelengths of about 630 nanometres. Commensurate with up to 80 percent entrance and internal light losses of the specified plastic rods, to meet vehicular regulatory lighting illumination specifications, the disclosure's lamps must produce usable light intensities of more than one order of magnitude greater than the lamps of the aforesaid conventional lighting system. Furthermore, Viola's disclosure teaches no means of heat removal from the light source enclosure. As taught in European Patent Number EP 0 911 578 A2, 1999, degradation of plastic rods and fibers from heat, infrared, and ultra-violet radiation will occur with conventional incandescent lamps as small as 30 watts. With the much larger lamps indicated for Viola's system, the degradation of the plastic rods is exacerbated, with melting and burning of the rod ends a near certainty. Such large wattage lamps may also place an unacceptable burden on the towing vehicle's electrical system.

Viola discloses no mechanical connection or sealing means for interfacing the plastic rods to either the light source enclosure, the light turning devices, or the taillight assemblies, though the latter two are proposed as submersible. Furthermore, there is no means presented for the control of the light exiting the rods to fill the area of the emitting aperture of the taillights, nor are provisions shown for the required license plate illumination, white light, and side markers, amber light.

Viola's disclosure teaches that the plastic rods are to be hot-formed to conform to the trailer frame, which is an expensive, custom, process particular to each trailer type and size. Further, any desired coating and/or sheathing of the plastic rods would have to be applied subsequent the forming process, which those skilled in the art will recognize as a difficult and expensive process. The rigid, inflexible rods are shown attached to the top, and side portions of the trailer frame, and are thus subject to physical damage during normal operations associated with boat trailers, and if not coated or sheathed will suffer degradation from exposure to sunlight. The acquisition of replacements of damaged rods, due to custom forming and manufacture, would be difficult and expensive for the user, especially when bundled rods at the light source separate and diverge to opposite sides of the trailer.

Therefore, it can be appreciated that there exists a continuing need for a new and improved boat trailer with an energy efficient, economical, watertight lighting system utilizing standard manufacture, flexible, readily replaceable, fiber-optic cable assemblies with environmentally secure connectors; a remote, efficiently coupled, long-lived, high brightness, low electrical power consuming, low heat generating light sources, disposed on either the trailer or the towing vehicle.

### SUMMARY OF THE INVENTION

In view of the foregoing disadvantages inherent in the known types of boat trailers now present in the prior art, the present invention provides an improved boat trailer employing immersible fiber-optic lighting means. As such, the general purpose of the present invention, which will be described subsequently in greater detail, is to provide a new and improved boat trailer employing immersible fiber-optic lighting means and method which has all the advantages of the prior art and none of the disadvantages.

Obviating the deficiencies of the prior art, the present invention provides for a boat trailer incorporating an optical distribution system for marker, tail/running, stop, turn signal, hazard, and backup lighting functions. Herein, the word “conductor”, unless otherwise specified, shall mean a bundle of a multiplicity of glass or plastic optical fibers for the low loss transmission of light.

First provided is a plurality of remote, high output, low power consuming, solid state, light sources, housed within an environmentally sealed enclosure. The enclosure is disposed at either the forward end of the trailer or the aft end of a towing vehicle. The light sources provide for each of the above stated lighting functions for each side of the trailer. The light sources are electrically connected to a towing vehicle's lighting system and optically coupled, either directly, or through light condensing means, to environmentally sealed, bulkhead type, fiber-optic connecting fittings. Electrical circuitry, to drive and provide current limiting for the light source emitting elements is disposed within the enclosure. Provided on the enclosure is a multi-conductor, environmentally sealing, electrical bulk-head connector, such as those manufactured by the Molex Corporation.

Next provided is a plurality of flexible, reflectively clad, sheathed, glass and/or plastic fiber-optic cables, made-up to length, with environmentally securing end connectors. The cable is constructed of standard manufacture, communications grade fiber-optic cable.

Next provided are fiber-optic cable tap devices, known to the art, utilizing either total internal reflection (TIR) means, or the redirection of a proportionate quantity of the multitude of fibers comprising a conductor. The tap devices function to extract a specific percentage of the light transmitted though a fiber-optic cable to a side outlet for distribution among a plurality of emitting apertures performing similar lighting functions, such as side markers.

Next provided are light emitting apertures in the form of fully sealed fixtures ensuring environmental integrity. The fixtures incorporate light fittings for side, top, or bottom inlets. Light diffusion and control from the entering beam to the full area of the light emitting aperture is accomplished through lenses and/or critical angle reflectors. Appropriate beam shaping lenses are disposed at the emitting apertures to meet regulatory specifications. Some fixtures may be a combination type, having multiple light input sources and multiple light emitting apertures, to serve diverse requirements such as tail, running, stop, turn signal, hazard, side marker, and license plate lighting.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved boat trailer employing immersible fiber-optic lighting means which has all of the advantages of the prior art boat trailers and none of the disadvantages.

It is another object of the present invention to provide a new and improved boat trailer employing immersible fiber-optic lighting means which may be easily and efficiently manufactured and marketed.

It is further object of the present invention to provide a new and improved boat trailer employing immersible fiber-optic lighting means which is of durable and reliable constructions.

An even further object of the present invention is to provide a new and improved boat trailer employing immersible fiber-optic lighting means which is susceptible of a low cost of manufacture with regard to both materials and labor, and which accordingly is then susceptible of low prices of sale to the consuming public, thereby making such boat trailer employing immersible fiber-optic lighting means economically available to the buying public.

Even still another object of the present invention is to provide a boat trailer employing immersible fiber-optic lighting means incorporating an optical distribution system for market, tail/running, stop, turn signal, hazard, and backup lighting functions.

Lastly, it is an object of the present invention to provide a new and improved a boat trailer with a plurality of light sources housed within a sealed enclosure in which the sources are electrically connected to a towing vehicle's lighting system and optically coupled through light condensing means to fiber-optic connecting fittings. Electrical circuitry for the light source emitting elements is disposed within the enclosure and a multi-conductor electrical bulk-head connector is on the enclosure. A plurality of fiber-optic cables have environmentally securing end connectors. Fiber-optic cable tap devices function to extract a specific percentage of the light transmitted through a fiber-optic cable to a side outlet for distribution among a plurality of emitting apertures performing similar lighting functions. Light emitting apertures with light diffusion and control from the entering beam to the full area of the light emitting aperture is accomplished through lenses and/or critical angle reflectors.

### BRIEF DESCRIPTION OF THE DRAWINGS

The invention will be better understood and objects other than those set forth above will become apparent when consideration is given to the following detailed description thereof. In the drawings wherein closely related figures may have the same number but different alphabetic suffixes. For clarity, elements of the invention may be expanded in proportional scale and/or in forms simplified for assembly views. After once illustrated and delineated in text, similar components differing only in parametric dimensions may not be shown again, for clarity of this teaching. The drawings and expositions assume a right or starboard-side, roadway, driving lane. It is expected that the reader will envision the transpositions of elements and assemblies required for the invention to be applicable in countries wherein the left or port-side of the roadway is the accepted norm. Unless otherwise specified in the drawing descriptions, “forward” and “fore” shall mean the direction toward the right side of the drawing, and in the case of a mirror-imaged, interrupted assembly drawing, the items to the right shall be construed as the primary object being described, although the items to the left may be referenced.

The description that follows makes reference to the annexed drawings wherein:

FIGS. 1 and 1A show isometric views of a typical embodiment of the invention as a float-on boat trailer assembly.

FIGS. 2 and 2A show front and edge views of encapsulated, multi-function, large arrays of light emitting diodes (LEDs) for high illumination level requirements such as stop and turn signaling, and back-up lighting.

FIGS. 3 and 3A show, in plan and side views, encapsulated, small arrays of white LEDs for lessor light level requirements such as license plate illumination.

FIG. 4 shows a partial section view through a fiber-optic cable assembly.

FIG. 5 shows a section view through a light condensing/collimating fitting mated with a fiber optic cable end.

FIG. 6 shows a section view through a light dispersion fitting, loosely made-up to a fiber-optic cable end.

FIG. 7 shows a section view through a 90° light turning/dispersion fitting.

FIG. 7A shows an end view of the 90° light turning/dispersion fitting.

FIG. 8 shows a vertical section view through the port side of a light source assembly.

FIG. 9 shows an isometric view of the starboard taillight assembly.

FIG. 10 shows an isometric view of a port side taillight assembly.

FIG. 11 shows a section view through a port side taillight module.

Similar reference numerals designate similar parts throughout the several figures. Following is a list of the drawing reference numerals.

### DRAWING REFERENCE NUMERALS

| | | | |
|---|---|---|---|
| 22 | Boat Trailer Frame | 22A | Port Girder |
| 22B | Starboard Girder | 22C | Tongue |
| 22D | Trave | 22E | Frame Hitch Coupler |
| 22F | Hull Support Beam | 22G | Keel Roller |
| 22H | Hull support Rail | 23 | Running Gear Assembly |
| 23A | Axle | 23B | Wheel & Tire Assembly |
| 23C | Trailer Suspension | 24 | Winch Post Fabrication |
| 24A | Post Support Stanchion | 24B | Post |
| 24C | Base Plate | 25 | Winch Post Assembly |
| 26 | Winch Assembly | 26A | Winch Mechanism |
| 26B | Hull Stop Roller | 26C | Winch Assembly Bracket |
| 30 | Light Source Assembly | 30A | Light Source Assembly Housing |
| 30B | Light Source Assembly Cover | 30C | Housing Threaded Boss |
| 30D | Alignment Bore | 30E | Backplane |
| 31 | Electrical Bulkhead Connector | 31A | Cable Parking Connector |
| 35 | Module Encapsulation | 35A | Module Mounting Hole |
| 35B | Encapsulation Riser | 35C | Module Condensing Lens |
| 35D | Module Mounting Holes | 36 | Taillight Source Module |
| 36A | Red Light Emitting Diode | 36B | Taillight Circuit Board |
| 37 | Marker Source Module | 37A | Amber LED |
| 37B | Marker Circuit Board | 38 | License Source Module |
| 38A | License Source Circuit Board | 39 | Backup Light Module |
| 39A | White LED | 39B | Backup Circuit Board |
| 40 | O-Ring Seal | 41 | Electrical Cable Assembly |
| 41A | Electrical Cable | 41B | Cable End Female Contact |
| 41C | Cable End Female Contact | | Connector |
| | Connector | 42 | Bearing Washer |
| 43 | Fitting Retaining Nut | 46 | Light Condensing Fitting |
| 46A | Fitting Body | 46B | Body Hex Flange |
| 46C | Alignment Boss | 46D | Fitting Nosepiece |
| 46E | Cable Nut Mating Boss | 46F | Cable End Receiving Cavity |
| 46G | Rod Bore | 46H | Collimating Lens Socket |
| 46I | Condensing Lens Socket | 46J | Condensing Lens Outlet |
| 46K | Light Coupling Rod | | Aperture |
| 46M | Collimating Lens | 46L | Elastomeric Retainer |
| 46P | Condensing Lens | 46N | Collimating Lens Retainer |
| 47 | Light Dispersion Fitting | 46Q | Condensing Lens Retainer |
| 47B | Body Hex Flange | 47A | Fitting Body |
| 47D | Fitting Nosepiece | 47C | Alignment Boss |
| 47F | Cable End Receiving Cavity | 47E | Cable Nut Mating Boss |
| 47H | Dispersion Lens | 47G | Diffuser Lens Cavity |
| 47J | Primary Light Diverging | 47I | Lens Cylindrical Section |
| | Surface | 47K | Secondary Light Diverging |
| 47L | Dispersion Lens Retainer | | Surface |
| 48A | Fitting Body | 48 | Rt. Angle Dispersion Fitting |
| 48D | Mounting Thread | 48B | Body Hex Flange |
| 48E | Cable Nut Mating Boss | 48C | Alignment Boss |
| 48G | Rod Bore | 48F | Cable End Receiving Cavity |
| 48I | Positioning Slot | 48H | Rod Clearance Bore |
| 48K | Light Diverging Surface | 48J | Light Guide Outlet Arm |
| 48M | Light Guide Inlet Arm | 48L | Critical Angle Surface |
| 49 | Light Guide Retainer | 48N | Extended Nosepiece |
| 52 | Backup Light Module | 50 | Side Marker Fixture |
| 53 | Port Taillight Assembly | 52A | Backup Module Lens |
| 53B | License Plate (Tag) | 53A | Port Taillight Assembly |
| 54A | Port Taillight Housing | | Bracket |
| 54C | Taillight Marker | 54 | Port Taillight Module |
| | Lens/Reflector | 54B | Taillight Aft Lens |
| 54E | Dispersion Fitting Orifice | 54D | License Illumination Lens |
| 54G | License Illumination Aperture | 54F | Turning Fitting Orifice |
| 54I | Side Lens Seal | 54H | Aft Taillight Aperture |
| 54K | License Lens Seal | 54J | Aft Lens Seal |
| 57 | Starboard Taillight Assembly | 54L | Marker Lens Aperture |
| 58 | Starboard Taillight Module | 57A | Starboard Taillight Bracket |
| 60 | Fiber-Optic Cable Assembly | 58A | Taillight Fixture Housing |
| 60B | Fiber Optic Bundle | 60A | Fiber-Optic Cable |
| 60D | Bundle End, Optical Flat | 60C | Fiber Optic Cable Sheathing |
| 61A | Ferrule Nosepiece | 61 | Fiber Optic Cable End Ferrule |
| 61C | Ferrule Bearing Flange | 61B | Ferrule Crimp Barrel |
| 61E | Fiber Bundle Bore | 61D | Cable Bore |
| 61G | Flange Seal Bearing Face | 61F | Flange Spring Bearing Face |
| 62A | Nut Jam Boss | 62 | Fiber Optic Cable End Nut |
| 62C | Nut Spring Bearing Face | 62B | Nut Mating Thread |
| 64 | O-Ring Seal | 63 | Wave Tension Spring |
| 72 | 90° Beam Turning Elbow | 70 | Beam Splitting Tee |

### DESCRIPTION OF THE PREFERRED EMBODIMENT

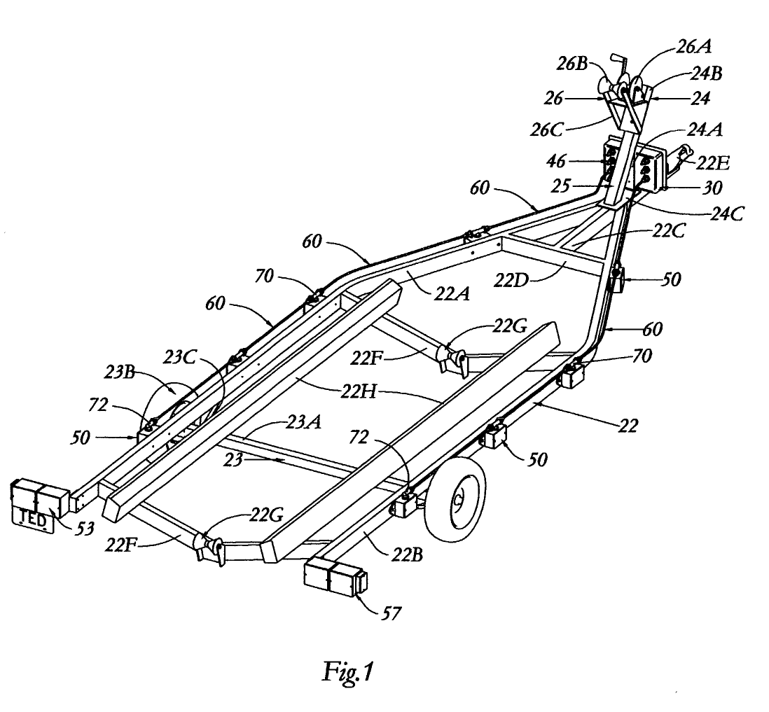

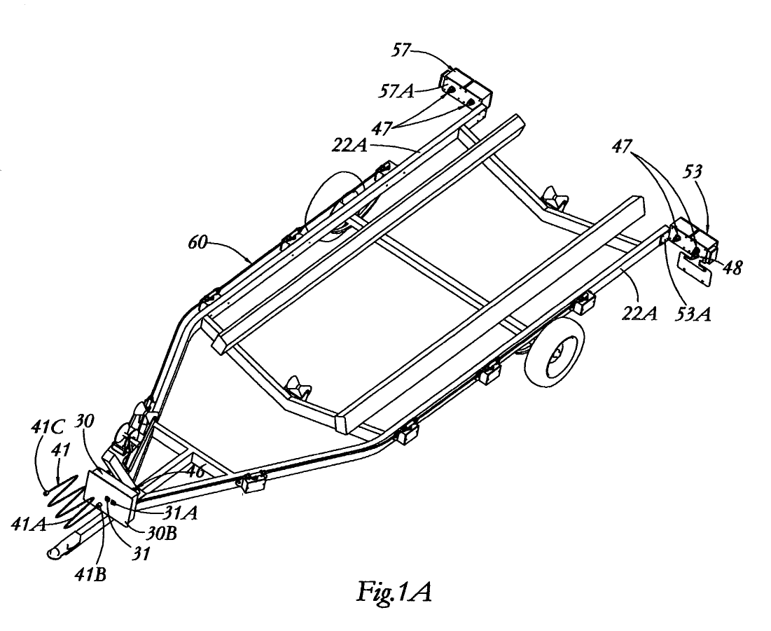

With reference now to the drawings, and in particular to FIG. 1 which is a starboard, aft or stern, isometric view and FIG. 1A which is a port, forward or bow, isometric view, the preferred embodiment of the boat trailer employing immersible fiber-optic lighting means. These drawings indicate the principle assemblies and components, along with their dispositions, that comprise the invention, typically, however, the functional description of the invention may not be set forth in the description of the aforesaid drawings. The functionality description of the invention may be revisited, after teaching the means and purpose of the components and assemblies through the descriptions of the subsequent drawings.

First provided is a boat trailer comprising a frame 22, a running gear assembly 23, and a winch post assembly 24.

The frame 22 is composed of a hitch coupler 22E, for attachment to a towing vehicle, not shown, disposed at the forward end of a tongue 22C dispositioned forward on the frame longitudinal axis with the tongue affixed to the midpoint of a trave 22D. An angle formed port girder 22A and an angle formed starboard girder 22B are joined to the ends of the trave 22D just forward of the midpoint of the angled portion of the girders. The aft portions of the girders 22A 22B, are aligned parallel to the frame longitudinal axis. With the forward angled portions thereof converging and affixed to an intermediate point of the tongue 22C and the respective vertical faces of thereof, a wishbone shaped carriage results.

Next provided are at least two hull support beams 22F affixed mesial the interior vertical faces of the girders 22A 22C; one just aft of the bend forming the angularity of the girders, and one just forward of the aft end of the girders. For trailers accommodating larger boats, additional beams 22F may provided between those shown. Attached to the midpoint of the beams, and protruding above, are keel roller assemblies 22G for guiding the boat onto the trailer.

Next provided, affixed to the beams 22F, are appropriately shaped, spaced, and cushioned, rails 22H for the support of a boat during transit.

Next provided is a running gear assembly 33. The running gear assembly is attached to the frame 22, via a suspension means 23C, and disposed longitudinally such that the weight distribution of the loaded trailer has roadworthy handling characteristics when attached to a towing vehicle. The assembly comprises; an axle 23A, and a wheel and tire assembly 23B, two of which are diametrically positioned about the center of the axle 23A, and a suspension means 23C such as a spring or a spring and damper combination.

Next provided is a winch post assembly 25. The winch post assembly is disposed and attached to the frame structure proximate the juncture of the girders 22A 22B with the tongue 22C. The winch post assembly comprises: a welded fabrication 24 of a base plate 24C, a post 24B, and a post support stanchion 24A; and a winch assembly 26. The winch assembly, disposed at the top of the winch post 24B positioned aft, comprises a winch bracket 26C attached to the post whereupon a winch mechanism 26A resides top and forward thereon, and a hull stop roller 26B resides aft.

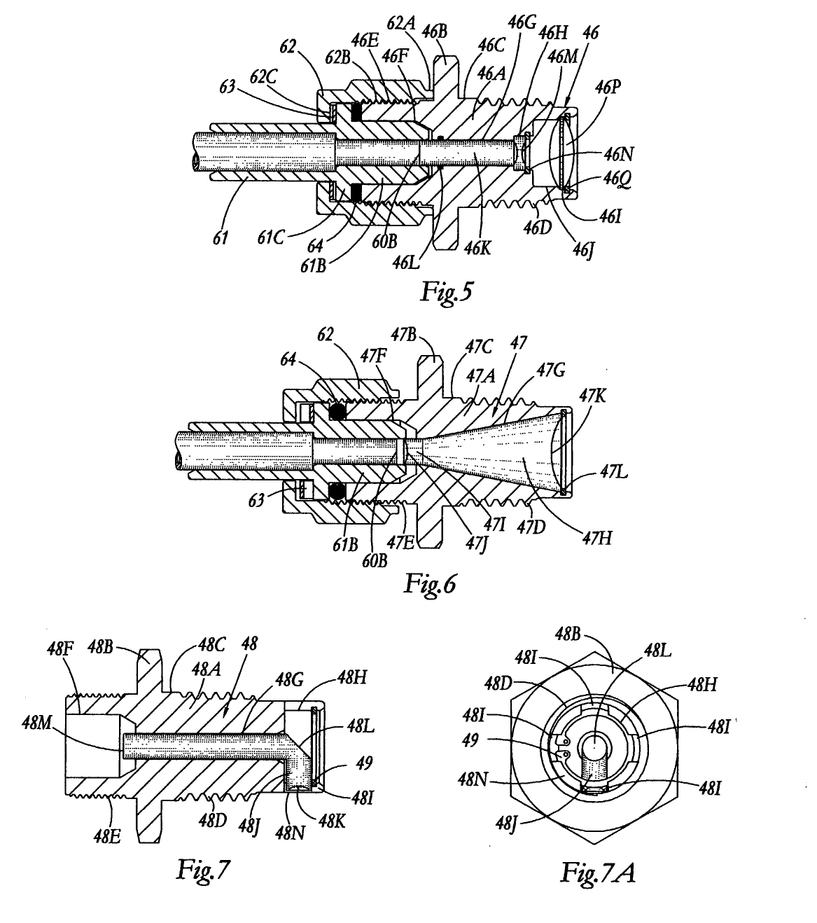

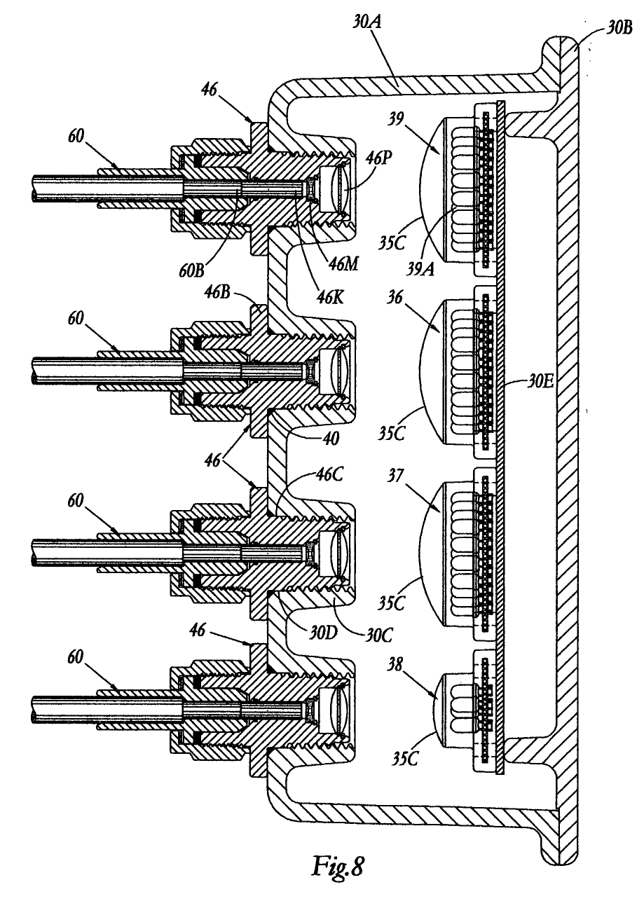

Next provided is a light source assembly 30. The light source assembly is attached to the stanchion 24A, forward apposition. The light source assembly has a multitude of light condensing fittings 46 protruding from the port and starboard sides of the aft face thereof. Note FIGS. 5 and 8. A multitude of side marker fixtures 50 are disposed along the outboard port and starboard faces of the frame 22, with quantities and locations being in accord with regulatory requirements. The aft most side markers have a prism-type 90 degree beam turning elbow 72, known to the art, fitted thereto. The fixtures forward of the aforementioned are fitted with a percentage beam splitting tee 70, also known to the art.

Next provided is a fiber optic cable assembly 60. The cable assembly is on the port side of the trailer and is connected to a respective light condensing fitting 46, routed and connected to a beam splitting tee 70 of the forward most side marker 50. As required, additional cable assemblies 60 inter-connect the light control fittings 70 72 of the port side markers 50. The cable assembly 60, being somewhat flexible, is secured to the trailer frame, not shown, for clarity with clamps, straps or other means common to the art. The starboard side marker requirements are provided through the same means as the port side.

Next provided is a port taillight assembly 53. Note FIG. 1A. The port taillight assembly is disposed at and attached to the aft, outboard end of the port frame girder 22A via a bracket 53A. Likewise, a starboard taillight assembly 57 is attached to the starboard frame girder 22B via a bracket 57A. A multitude of specific function fittings 47, 48 of the aforementioned assemblies 53, 57 are connected to the respective condensing fittings 46 of the light source assembly 30 with fiber optic cable assemblies 60, not shown.

An environmentally sealing, keyed, multi-conductor, bulkhead type, electrical connector 31 is next provided. The electrical connector 31 has male contacts and threads, such as manufactured by the Molex Corporation. The electrical connector is through mounted proximate the face center of a light source assembly cover 30B. An electrical cable assembly 41 electrically connects the light source assembly 30 to the towing vehicle's electrical system. The cable assembly comprises a sheathed multi-conductor, self-coiling cable 41A terminated at one end with a keyed connector 41B, having female electrical contacts and an internally threaded coupling nut for mating with the aforesaid connector 31. The other end has a keyed, connector 41C with male electrical contacts and an internally threaded nut for mating with a matching receptacle on the towing vehicle, not shown. A non-active bulkhead connector 31A, that mates with the cable end connector 41C, is provided on the cover 30B for parking and storage of the cable assembly when not connected to the towing vehicle.

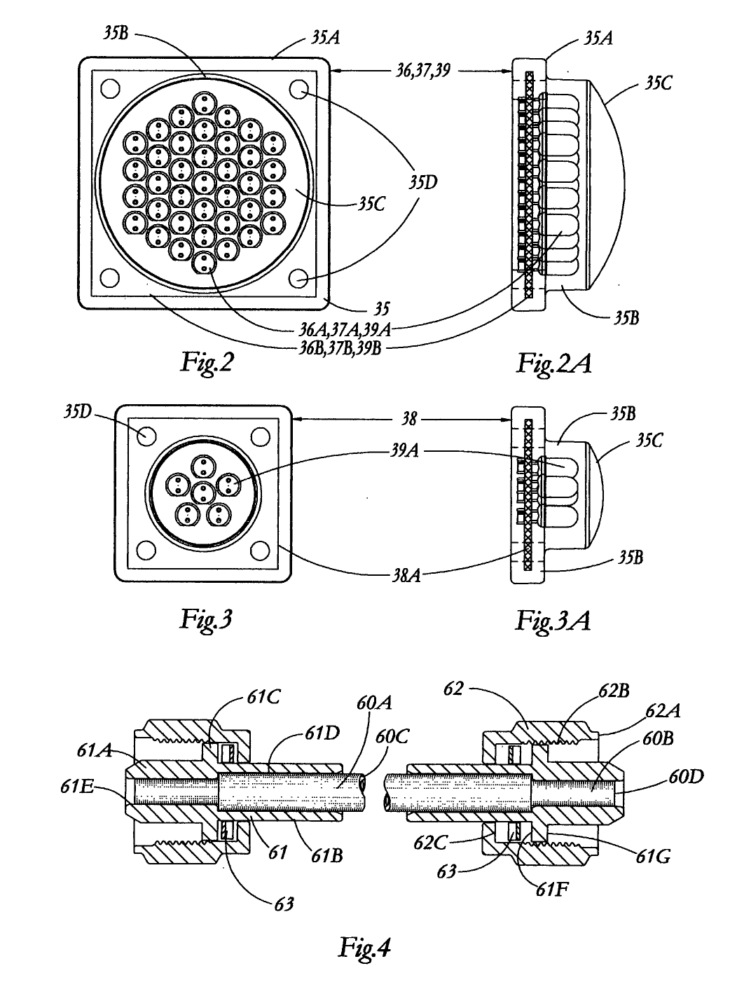

A taillight source module 36 is next provided. Note FIGS. 2 and 2A. The taillight source module comprises an array of ultra-high intensity, narrow angle light emitting diodes 36A having a dominant emission wavelength of about 630 nanometres, is disposed upon a circuit board 36B, and is fully encapsulated within a molding 35 of transparent polymer. The molding is composed of a square flange base 35A, with mounting holes 35D arrayed proximate the corners thereof, and upon which a cylindrical riser 35B, crowned by a specifically shaped dome forming a concentrating lens aperture 35C, is centrally disposed. With the exception of the lens aperture 35C, the entire molding is metallized to create a reflective coating for control of internally reflected light.

Next, a marker light source module 37 is provided. The marker source module utilizes an array of ultra-high intensity, narrow angle, amber light emitting diodes 37A having a dominant emission wavelength of about 595 nanometres disposed on a unique circuit board 37B. In all other respects it is identical with the aforesaid module 36.

Next, a backup-light source module 39 is provided. The backup-light source employs an array of high intensity white light emitting diodes 39A on a unique circuit board 39B. In all other respects it is identical to the aforementioned module 36.

A license light source module 38 is next provided. Note FIGS. 3 and 3A. The license light source module employs a smaller array of white light emitting diodes 39A on a unique circuit board 38A. With the exception of parametrically smaller dimensions, it is identical to the aforementioned module 36.

A flexible, fiber optic cable assembly 60 is next provided. Note FIG. 4. The flexible, fiber optic cable assembly is composed of an appropriate length of standard-manufacture, environmentally-sheathed 60C, fiber optic cable 60A, employing a bundle of reflectively clad, bonded, light conducting fibers 60B, with cut and polished ends such that an optical flat 60D results. The ends of the fiber optic cable 60A are disposed within a cable-end ferrule 61. The ferrule is of one-piece construction with a cylindrical nosepiece 61A portion, chamfered at the forward end, and terminating aft, in, and coaxial with a cylindrical flange 61C portion. The flange portion has a sealing face 61G forward, and a spring bearing face 61F aft, from which a cylindrical crimping barrel 61B, concentrically disposed, protrudes aft. Within the ferrule, an axial bore 61E, diametrically sized to receive the fiber bundle 60B, extends aft from the forward most end of the nosepiece 61A until about coincident with the spring bearing face 61F of the flange 61C. A larger axial bore 61D within the ferrule, diametrically sized for the sheathed cable 60A, extends aft from the interior terminus of the bore 61E to the end of the barrel portion 61B. The optically flat end 60D of the fiber bundle 60B is axially positioned within the bore 61E of the ferrule by the end of the sheathing 60C engaging the interior terminus of the bore 61D. Hexagonal crimping, well known to the art, of the ferrule barrel 61B retains and secures the disposition of the cable 60A within the ferrule 61.

A compression type wave spring 63 is next provided. The compression type wave spring is concentrically disposed over the barrel 61B portion, immediately aft, of the flange 61C portion of the aforesaid ferrule.

Next provided is a cable-end hex-nut 62. The cable-end hex-nut is configured similar to a typical compression-type tubing nut, well known to the art, having an interior thread 62B to mesh with the external threads of various connection devices, hereinafter described, is concentrically disposed over the crimping barrel 61B of the ferrule 61. The nut is disposed such that the spring 63 is mesial the aft interior bearing face 62C of the aforesaid nut and the spring bearing face 61F of the flanged portion of the aforesaid cable end ferrule 61. The nut 62, having a forward boss 62A, through frictional forces with a face element of mating device, disposes and secures the end elements of the cable assembly 60.

A light condensing/collimating fitting 46 is next provided. Note FIG. 5. The light condensing/collimating fitting comprises: a one-piece body 46A, a double convex condensing lens 46P with a retainer 46Q, a double concave collimating lens 46M with a retainer 46N, light coupling rod 46K, and a rod retention means 46L. The body 46A exteriorly has a cylindrical nosepiece portion 46D with threads forward and an unthreaded alignment boss 46C aft. The nosepiece portion extends aft from the forward end of the body into a hexagonal mounting flange portion 46B, which extends aft into a cylindrical cable connection boss 46E, which protrudes aft, and is threaded to mate with the aforesaid nut 62. The nosepiece 46A, flange 46B, and connection boss 46E is concentric about the longitudinal axis of the aforesaid body.

Extending co-axially aft from, and concentric with, the forward end of the nosepiece 46D is a four-step counter-bore. A condenser lens inlet socket 461 disposing the condenser lens 46P between the aft terminus of the socket and the retainer 46Q comprises the first step of the counter-bore, whilst a lens outlet aperture 46J comprises the second. A collimating lens socket 46H disposing the collimating lens 46M, between the aft terminus of the socket and the retainer 46N, constitutes the third step of the aforesaid counter-bore. A light outlet bore 46G, continuous aft, diametrically and concentrically matched to the aft light control surface of the aforesaid lens 46M comprises the final step of the aforesaid counter-bore. A reflectively clad, light coupling rod 46K, each end configured to an optical flat, is disposed within the aforesaid bore 46G with the forward end abutting the collimating lens 46M, and the aft end protruding into an cylindrical cavity 46F. The rod may be frictionally retained by an elastomeric ring 46L, cemented in place, or secured by other means known to the art.

The cavity 46F, extending forward from the aft most end of the body 46A to about coincident the aft face of the flange 46B, is configured to match, guide, and receive the ferrule nosepiece 61B of an aforesaid cable assembly 60.

A light dispersion fitting 47 is next provided. Note FIG. 6. The light dispersion fitting comprises a one-piece body 47A, a double concave light dispersing lens 47H, and a lens retainer 47L. The body 47A, exteriorly similar to the aforesaid body 46A, has a nosepiece portion 47D, a hexagonal flange portion 47B, and cable connection boss 47E. A cavity 47F is identical in form and disposition to the cavity 46F.

The light dispersing lens 47H is next provided. The light dispersing lens is a diverging type and has a truncated conical structure with a cylindrical structure 47I diametrically equivalent to an optical flat 60B of the fiber-optic cable assembly 60. The light dispersing lens protrudes from a truncated apex of the aforesaid conical structure. Whereby, the base of the aforesaid conical structure faces forward and is concentrically disposed with the cylindrical structure of the lens and the longitudinal axis of the fitting body 47A. A concave light refractive surface 47J, residing within the aft end of the aforesaid cylindrical structure, and concentric therewith, serves to disperse the nearly co-linear light exiting the aforesaid fiber bundle, throughout the conical portion of the lens. A second, concave, refractive surface 47K, residing concentrically at the forward end of the aforesaid lens, serves to further disperse the exiting light throughout a desired solid angle. The lens is disposed within a cavity 47G of the fitting body 47A. The lens may be secured by a retainer 47L being a snap-ring or similar retainer, or other means known to the art.

The nut 62 is loosely threaded onto the boss 47E with the compression spring 63 and an o-ring seal 64, disposed over the ferrule nosepiece 61B, shown in their relaxed state. Note FIG. 6. As the cable end assembly is made up to a fitting, the cylindrical wall of the cavity 47F guides the nosepiece 61B over the cylindrical portion 47I of the lens 47H or, as shown in FIG. 5, the aft end of the rod 46K. In FIG. 5, the nut 62 is fully threaded on the boss 46E with the nut boss 62A jammed against the aft face of the fitting flange 46B. The spring 63, being compressed between the forward interior face 62C of the nut and the aft face of the ferrule flange 61C, provides a constant force to the optical flat end of the fiber bundle 60B, against the optical flat end of the rod 46K, or in FIG. 6, the aft face of the lens 47H. The o-ring 64 is compressed between the forward face of the ferrule flange 61C and the aft face of the fitting boss 46E thus affecting a secure environmental seal. The aforesaid arrangement being typical of all connections between a cable assembly 60 and the various fittings and devices of the invention.

Referring to FIGS. 7 and 7A. A 90° light turning and dispersion fitting assembly 48 comprising a one-piece body 48A, a light guide rod 48G, and a rod retention device 49. Describing the body 48A, from fore to aft, as having: an extended, cylindrical nosepiece 48N with a radial array of at least four slots 48I, a threaded portion 48D, and an alignment boss 48C. And with a flange 48B, a cable connection boss 48E, and a cavity 48F, being identical to those features of the aforesaid fittings, 46 and 47.

An “L” shaped, cylindrical, reflectively clad, light guide 48G is next provided. The light guide has a long arm 48M and a short arm 48J perpendicular to the long arm. A 45 degree, polished flat 48L, affecting an internal light reflecting surface, is positioned at the intersection of, and perpendicular to, the longitudinal axes of the aforesaid arms. The short arm has a concave, light diverging surface 48K in the outboard end, and the long arm terminating aft in a light input optical flat. The long arm is disposed within a coaxial throughbore of the body 48A with the short arm in one of the radial slots 48I in accord with a desired light discharge direction relative to the body threads 48D. A retaining means 49, such as the snap-ring shown, secures the deposition of the light guide. Light entering the aft end of the light guide rod is reflected 90 degree to the concave light diverging surface 48K whereby it exits being dispersed through a desired solid angle.

Shown is FIG. 8 is a vertical section view through the light source assembly 30 serving the trailer port side light fixtures. A housing 30A has a multitude of threaded bosses 30C in the aft face. The bosses have an entry bore 30D, chamfered aft. Disposed within each of the housing bosses is a light condensing/collimating fitting 46 to which a fiber-optic cable assembly 60 is connected. Predisposed over the fitting boss 46C is an o-ring seal 40, compressed into the chamfer of the bore 30D by the flange 46B to affect a secure, water tight seal. An interference fit of the fitting boss 46C and the housing bore 30D further ensures environmental sealing, precisely aligns the fitting axes with those of the aforesaid bosses, and obviates loosening of the fittings.

A subassembly, comprising a housing cover 30B and a backplane 30E attached to the aft side thereof is disposed over a forward opening of the housing 30A. Disposed on the aft face of the backplane, coaxial and concentric with an aforesaid fitting 46, is the back-up light source module 39, the taillight source module 36, the marker light source module 37, and the license tag light source module 38, with the module converging lens surfaces 35C being in apposition to the fitting converging lens 46P.

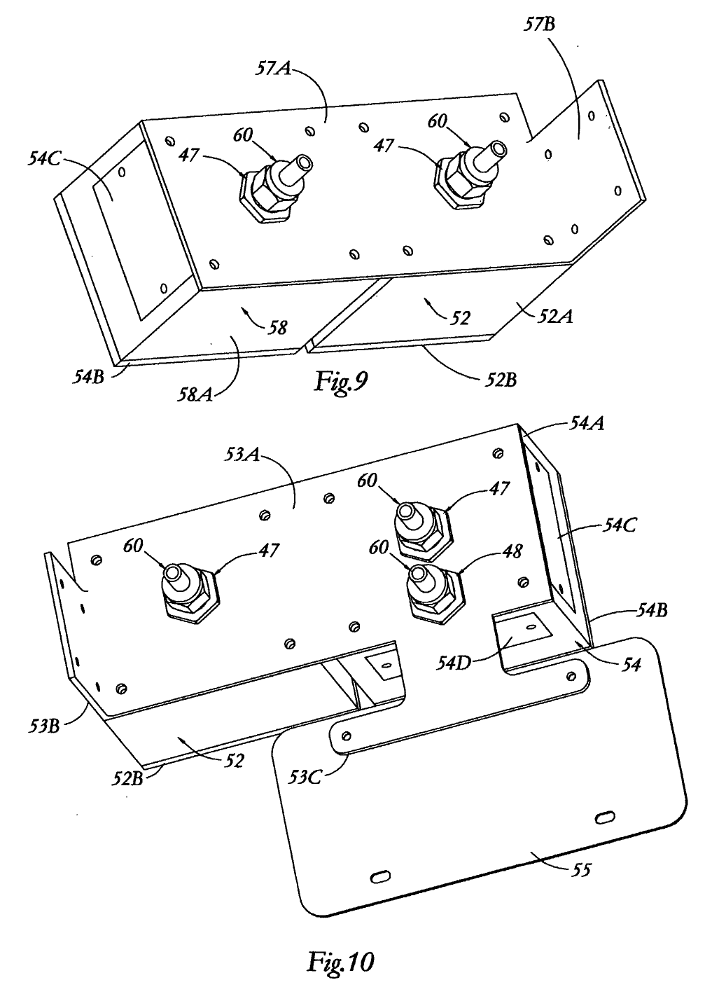

Considering the arrangement of the back-up module 39 and a respective, opposing fitting 46 as a functional example of the other light source module and fitting arrangements, light from the light emitting diode array 39A passing through the convex, refractive surface 35C of the module converges is focused upon the forward aperture of the double convex, converging lens 46P of the fitting 46. Whereby, the light is focused upon the forward, active, concave surface of the diverging, collimating lens 46M and exits same as a nearly coherent beam which enters the forward end optical flat of the coupling rod 46K and subsequently the fiber bundle 60B of a fiber-optic cable assembly 60. The other end of the cable connects to a port side back-up fixture 52 via an aforesaid dispersion fitting 47. Note FIG. 9. The coherent beam of light is desirable for transmission loss minimization through the cable assembly 60 and, as light exits a fiber-optical cable essentially at the same angle in which it enters, for a predicable light input configuration to the aforesaid light control output fittings 47, 48. A similar arrangement, not shown, in the starboard, aft face of the light source assembly 30 serves the starboard side light fixtures.

A starboard taillight assembly 57 is next provided. Note FIG. 9. The starboard taillight assembly is composed of a mounting bracket 57A, a back up light fixture 52, a starboard taillight fixture 58, and two light dispersion fittings 47, shown connected to the ends of a cable assembly 60.

A frame attachment flange 57B of the bracket 57A protrudes forward, and the lens 52B of the backup light fixture 52 faces aft. The starboard taillight fixture 58 is disposed outboard on the aft surface of the bracket 57A, with the backup light fixture being likewise disposed inboard. The back-up light fixture comprises a housing shell 52A, fully open aft; and a prismatic lens 52B, disposed over the open end of the housing. A light dispersion fitting 47 is centrally disposed within the forward face of the aforesaid housing, through an opening in the bracket 57A. The starboard taillight fixture 58 composes a housing shell 58A, fully open aft and with an opening in the starboard housing face; a lenticular taillight lens 54B, disposed over the aft opening of the housing; a prismatic marker lens/reflector disposed over the starboard opening of the housing. A light dispersion fitting 47 is centrally disposed within the forward face of the housing through an opening in the bracket 57A. The light dispersion fittings are each connected forward with a cable assembly 60 to their respective starboard fittings of the light source assembly 30.

A port taillight assembly 53 is next provided. Note FIG. 10. The port taillight assembly comprises a bracket 53A, an aforesaid back-up light fixture 52, a port taillight fixture 54, a license plate tag 55, two light dispersion fittings 47, and a 90 degree light dispersion fitting 48.

When referencing a frame attachment flange 53B of the bracket 53A as protruding forward, and the lens 52B of the backup light fixture 52 as facing aft, the port taillight fixture 54 is disposed outboard on the aft surface of the bracket 53A, with the backup light fixture being likewise disposed inboard.

A port taillight fixture 54 is next provided. The port taillight fixture comprises a housing shell 54A, fully open aft, with openings in the port and bottom housing faces. A lenticular taillight lens 54B is disposed over the aft opening. A prismatic marker lens/reflector 54C is disposed in the starboard opening. Finally, a lenticular license tag lens 54D disposed in the bottom opening.

Two light dispersion fittings 47 are next provided. The light dispersion fittings are centrally disposed, through openings in the bracket 53A, in the forward housing faces of the backup light fixture and the port taillight fixture. A 90 degree light dispersion fitting 48 is positioned in the forward face of the port taillight fixture, below, and vertically inline with the fitting 47. The light dispersion fittings are each connected forward with a cable assembly 60, to their respective port fittings 46 of the light source assembly 30.

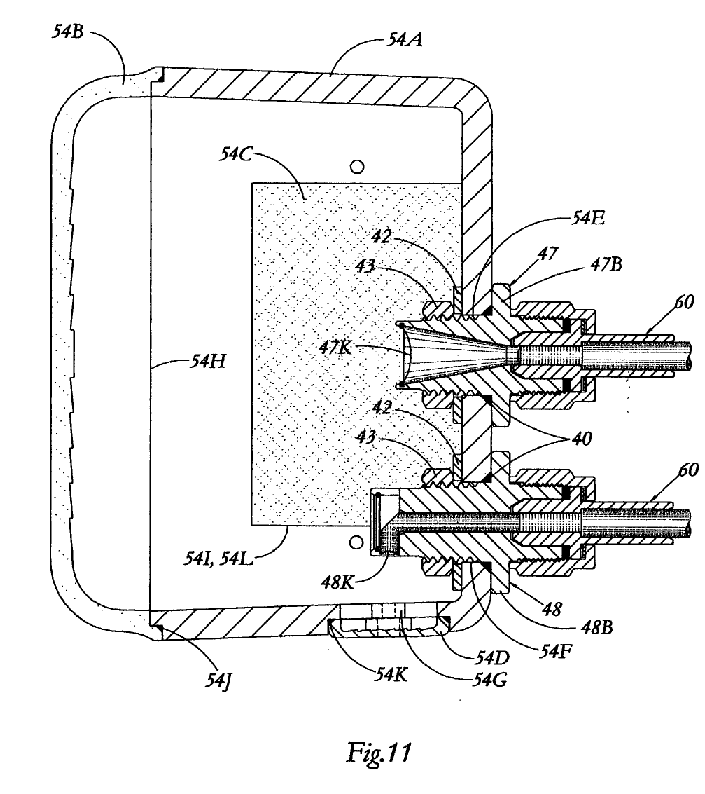

A vertical section view looking outboard, through the center of the port taillight fixture 54, and associated components is shown in FIG. 11. A fixture assembly is shown comprising a housing shell 54A, reflectively coated within. The shell has an aft tail lens aperture 54H with an exterior lens recess, a side marker lens aperture 54L with an exterior recess, not shown, a license illumination aperture 54G with an exterior recess, and an exteriorly chamfered dispersion fitting orifices 54E 54F. A lenticular taillight lens 54B has an interior recess and is disposed over the aperture 54H, compressing an elastomeric gasket 54J to affect a water-tight seal. A prismatic marker lens/reflector is disposed within the exterior recess of the aperture 54L, compressing an elastomeric gasket 54I not shown within the aforesaid recess to affect a water-tight seal. A two-way lenticular license illumination lens 54D is disposed within the external recess of the aperture 54G, compressing an elastomeric gasket 54K to affect a water-tight seal. A light dispersion fitting 47, shown mated with a fiber-optic cable assembly 60, is disposed, with the lens outlet surface 47K facing aft, in the aforesaid orifice 54E, and retained by a nut 43 drawn up to a bearing washer 42 and the flange 47B. An o-ring gasket 40 is compressed into the aforesaid chamfer by the fitting flange to affect a water-tight seal. Light entering the fitting from the attached cable assembly 60 exits through the diverging lens surface 47K at a solid angle greater than that required to fully illuminate the beam shaping taillight lens 54B. Whereby, a portion of the light impinges upon, and is reflected by the interior surfaces of the housing such that the marker lens/reflector 54C receives illumination.

A 90 degree light dispersion fitting 48 is next provided. The light dispersion fitting is shown mated with a fiber-optic cable assembly 60, is disposed in the aforesaid orifice 54F, with the lens outlet surface 48K being aft and facing downward, retained as in the previous exposition for the fitting 47. An o-ring gasket 40 is compressed into the aforesaid chamfer by the fitting flange 48B to affect a water-tight seal. Light entering the fitting from the attached cable assembly 60, exits through the diverging lens surface 48K, at a solid angle such as to fully illuminate the license illumination lens 54D. Whereby, the lens directs the light forward, horizontally, and downward to provide illumination for the license 55 in accord with regulatory requirements.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A boat trailer employing immersible fiber-optic lighting means comprising, in combination:
a plurality of remote, high output, low power consuming, solid state, light sources, housed within an environmentally sealed enclosure, the enclosure being disposed at either the forward end of the trailer or the aft end of a towing vehicle, the light sources providing for each of the above stated lighting functions for each side of the trailer, the lighting sources being electrically connected to a towing vehicle's lighting system and optically coupled, either directly, or through light condensing means, to environmentally sealed, bulkhead type, fiber-optic connecting fittings;
light source emitting elements and electrical circuitry to drive and provide current limiting for the light source emitting elements being disposed within the enclosure;
a multi-conductor, environmentally sealing, electrical bulk-head connector on the enclosure;
a plurality of flexible, reflectively clad, sheathed fiber-optic cables fabricated from the class of cables including glass and plastic, made-up to length, with environmentally securing end connectors, the cable being constructed of standard manufacture, communications grade fiber-optic cable;
fiber-optic cable tap devices selected from the class of tap devices including total internal reflection (TIR) means, and the redirection of a proportionate quantity of the multitude of fibers comprising a conductor, the tap devices functioning to extract a specific percentage of the light transmitted through a fiber-optic cable to a side outlet for distribution among a plurality of emitting apertures performing similar lighting functions, such as side markers; and
light emitting apertures in the form of fully sealed fixtures ensuring environmental integrity, the fixtures adapted for incorporating light fittings for side, top, and bottom inlets, light diffusion and control from the entering beam to the full area of the light emitting aperture accomplished through an optical element selected from the class of elements included lenses and critical angle reflectors, appropriate beam shaping lenses disposed at the emitting apertures to meet regulatory specifications, including fixtures of a combination type, having multiple light input sources and multiple light emitting apertures, to serve diverse requirements such as tail, running, stop, turn signal, hazard, side marker, and license plate lighting.

2. A boat trailer comprising:
a plurality of light sources housed within a sealed enclosure, the sources being electrically connected to a towing vehicle's lighting system and optically coupled through light condensing means to fiber-optic connecting fittings;
light source emitting elements and electrical circuitry being disposed within the enclosure;
a multi-conductor electrical bulk-head connector;
a plurality of fiber-optic cables with environmentally securing end connectors;
fiber-optic cable tap devices functioning to extract a specific percentage of the light transmitted through a fiber-optic cable to a side outlet for distribution among a plurality of emitting apertures performing similar lighting functions; and
light emitting apertures with light diffusion and control from the entering beam to the full area of the light emitting aperture being accomplished through optical elements.

3. The boat trailer as set forth in claim 2 wherein the fiber-optic cables are fabricated from the class of cables including glass and plastic.

4. The boat trailer as set forth in claim 2 wherein the optical elements are selected from the class of elements including lenses and critical angle reflectors.
